(19) United States
(12) Patent Application Publication
(10) Pub. No.: US 2017/0349183 A1
(43) Pub. Date: Dec. 7, 2017

(54) VEHICLE CONTROL SYSTEM, VEHICLE CONTROL METHOD AND VEHICLE CONTROL PROGRAM

(71) Applicant: HONDA MOTOR CO., LTD., Tokyo (JP)

(72) Inventors: Naoto Sen, Wako-shi (JP); Masahiko Asakura, Wako-shi (JP)

(73) Assignee: HONDA MOTOR CO., LTD., Tokyo (JP)

(21) Appl. No.: 15/609,257

(22) Filed: May 31, 2017

(30) Foreign Application Priority Data
Jun. 2, 2016 (JP) 2016-111011

(51) Int. Cl. B60W 50/00; G05D 1/00; B60W 10/20; B60W 50/08

(52) U.S. Cl. CPC B60W 50/0098; B60W 50/085; G05D 1/0088; B60W 10/20; B60W 2540/28; B60W 2710/30; B60W 2720/10; B60W 2710/20

(57) ABSTRACT

A vehicle control system comprises one or more content reproduction part for reproducing a content based on operation of an occupant of a vehicle, an automated driving control part for executing automated driving for automatically performing at least one of speed control and steering control of the vehicle, and a reproduction control part for controlling the content reproduction part based on the condition of the automated driving which is executed by the automated driving control part, in such a manner as to stop the reproduction of the content in the content reproduction part when the reproduction of the content is restricted, and thereafter to automatically resume the reproduction of the content in the content reproduction part when the restriction on the reproduction of the content is released.

### CROSS REFERENCES TO RELATED APPLICATIONS

The present application claims priority under 35 U.S.C. §119 to Japanese Patent Application No. 2016-111011, filed Jun. 2, 2016, entitled “Vehicle Control System, Vehicle Control Method and Vehicle Control Program.” The contents of this application are incorporated herein by reference in their entirety.

### TECHNICAL FIELD

The present disclosure relates to a vehicle control system, a vehicle control method and a vehicle control program.

### BACKGROUND

In recent years, a vehicle which is provided with a content reproduction device capable of reproducing various kinds of contents such as a DVD (Digital Versatile Disc) reproduction device, a television receiver and the like is realized. In connection with this, in order to prevent attention of an occupant who drives the vehicle from becoming distracted by viewing a television video image, etc., there is a technique which performs control and the like for stopping the reproduction of the contents during traveling of the vehicle (for example, see International Patent Publication No. 2011-158347).

### SUMMARY

However, in the conventional technique, since the control for stopping the reproduction of the contents is executed at every time when the vehicle traveling is started, the vehicle occupant is required to operate again the content reproduction device at the time the above control has been released. For example, in the vehicle realizing the technique (hereinafter, referred to as “automated driving”) for automatically controlling either one or both of the acceleration/deceleration operation and the steering operation of the vehicle, the predetermined safety is ensured also during the traveling of the vehicle, so that the reproduction of the contents may be allowed. However, it is assumed that the control for the above reproduction stop is performed also in this type of vehicle. In that case, there maybe cases where the convenience of the content reproduction device is impaired.

It is desirable to provide the vehicle control system, the vehicle control method and the vehicle control program which are capable of ensuring the safety and improving the convenience of the content reproduction device.

A vehicle control system according to a first aspect of the present disclosure comprises one or more content reproduction part for reproducing a content based on operation of an occupant of a vehicle, an automated driving control part for executing automated driving for automatically performing at least one of speed control and steering control of the vehicle, and a reproduction control part for controlling the content reproduction part based on the condition of the automated driving to be executed by the automated driving control part, in such a manner as to stop the reproduction of the content in the content reproduction part when the reproduction of the content is restricted, and thereafter to automatically resume the reproduction of the content in the content reproduction part when the restriction on the reproduction of the content is released.

According to a second aspect of the present disclosure, the reproduction control part is configured to reproduce the content from a stopping point of the content when the reproduction of the content in the content reproduction part is resumed based on the condition of the automated driving.

According to a third aspect of the present disclosure, the content comprises a video image content.

The vehicle control system according to a fourth aspect of the present disclosure, further comprises a storage part for storing the content, wherein the reproduction control part is configured to allow the storage part to store the content to be reproduced during a stopping period when the reproduction of the content in the content reproduction part is stopped, and to allow the content stored in the storage part to be read out and reproduced when the reproduction of the content in the content reproduction part is resumed.

According to a fifth aspect of the present disclosure, the reproduction control part is configured such that, after having resumed the reproduction of the content in the content reproduction part, the storage of the content into the storage part and the readout and reproduction of the content which is stored into the storage part in the past are performed concurrently.

According to a sixth aspect of the present disclosure, the content comprises a content which is distributed by a broadcast.

The vehicle control system according to a seventh aspect, further comprises a operation receiving part for receiving an instruction to continue the reproduction of the content in the content reproduction part, wherein the automated driving control part executes any of multiple driving modes which are different in degree of the automated driving and maintains the driving mode which does not restrict the reproduction of the content when the operation receiving part has received the instruction to continue the reproduction of the content.

The vehicle control system according to an eighth aspect of the present disclosure, further comprises a detection part for detecting the occupant riding the vehicle, wherein the reproduction control part is configured not to stop the reproduction of the content when the detection part detects other occupant than the occupant seated on a driver's seat of the vehicle.

According to a ninth aspect of the present disclosure, a vehicle control method comprises steps of executing automated driving for automatically performing at least one of speed control and steering control of the vehicle, and controlling reproduction of a content on the basis of the condition of the automated driving to be executed, such that the reproduction of the content is stopped when the reproduction of the content is restricted and thereafter the reproduction of the content is automatically resumed when the restriction on the reproduction of the content is released.

According to a tenth aspect of the present disclosure, a vehicle control program is configured to allow an onboard computer to perform processing which executes automated driving for automatically performing at least one of speed control and steering control of the vehicle and which controls reproduction of a content due to operation of the an occupant of the vehicle, on the basis of the condition of the automated driving to be executed, such that the reproduction of the content is stopped when the reproduction of the content is restricted and thereafter the reproduction of the content is automatically resumed when the restriction on the reproduction of the content is released.

According to the first to third aspects, the ninth and tenth aspects, for example, the vehicle occupant is not required to operate the content reproduction device at the time the reproduction of the content is resumed. Therefore, the convenience of the content reproduction device can be improved while ensuring the safety when the automated driving is performed.

According to the fourth to sixth aspects, for example, the vehicle occupant can view the content to be reproduced during the stopping period, later. Therefore, the convenience of the content reproduction device can be improved while ensuring the safety when the automated driving is performed.

According to the seventh aspect, for example, the vehicle occupant can continue viewing the content. Therefore, the convenience of the content reproduction device can be further improved while ensuring the safety when the automated driving is performed.

According to the eighth aspect, for example, the convenience of the content reproduction device can be improved further.

### BRIEF DESCRIPTION OF THE DRAWINGS

The advantages of the disclosure will become apparent in the following description taken in conjunction with the following drawings.

FIG. 1 is a diagram showing component elements of an own vehicle M of one embodiment;

FIG. 2 is a function configuration diagram focusing on a vehicle control system 100 in accordance with a first embodiment of the present disclosure, showing a function configuration diagram of the own vehicle M;

FIG. 3 is a configuration diagram of HMI 70 in accordance with the first embodiment;

FIG. 4 is a diagram showing a state in which a relative position of the own vehicle M with respect to a traveling lane L1 is recognized by an own vehicle position recognition part 140 in accordance with the first embodiment;

FIG. 5 is a diagram showing an example of an action plan generated for a certain section in accordance with the first embodiment;

FIG. 6 is a diagram showing an example of a configuration of a trajectory generation part 146 in accordance with the first embodiment;

FIG. 7 is a diagram showing examples of trajectory candidates generated by the trajectory candidate generation part 146B in accordance with the first embodiment;

FIG. 8 is a diagram representing, by trajectory points K, the examples of the trajectory candidates generated by the trajectory candidate generation part 146B in accordance with the first embodiment;

FIG. 9 is a diagram showing a traveling lane change target position TA in accordance with the first embodiment;

FIG. 10 is a diagram showing a speed generation model when assuming that speeds of three peripheral vehicles are constant in accordance with the first embodiment;

FIG. 11 is a diagram showing an example of operation propriety information 188 for each mode in accordance with the first embodiment;

FIG. 12 is a flowchart showing an example of reproduction control processing of contents in accordance with the first embodiment;

FIG. 13 is a diagram showing an example of screen control of a display device 82 in accordance with the first embodiment;

FIG. 14 is a flow chart showing an example of the reproduction control processing of the contents in accordance with a second embodiment;

FIG. 15 is a diagram showing an example of the screen control in the display device 82 in accordance with the second embodiment;

FIG. 16 is a diagram showing a relationship between the contents distributed by a broadcast and the contents reproduced on the display device 82 in accordance with the second embodiment;

FIG. 17 is a flow chart showing an example of the reproduction control processing of the contents in accordance with a third embodiment; and

FIG. 18 is a diagram showing an example of the screen control in the display device 82 in accordance with the third embodiment.

### DETAILED DESCRIPTION

Hereinafter, embodiments of a vehicle control system, a vehicle control method and a vehicle control program according to the present disclosure will be explained with reference to drawings.

### <Common Configuration>

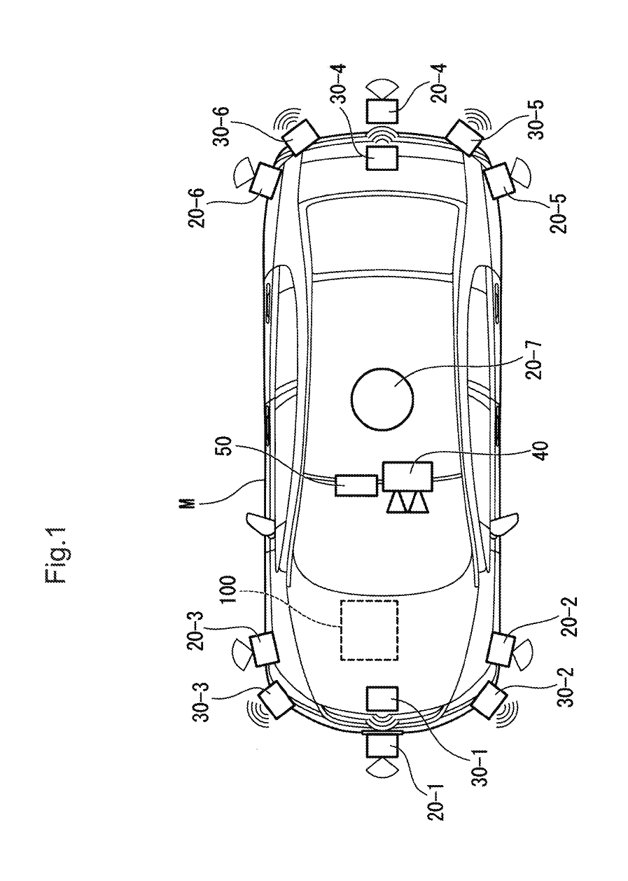

FIG. 1 is a diagram showing component elements of a vehicle (hereinafter, referred to as an own vehicle M) on which a vehicle control system 100 according to each of the embodiments is mounted. The vehicle on which the vehicle control system 100 is mounted is a motor vehicle such as a two-wheeled vehicle, a three-wheeled vehicle, a four-wheeled vehicle and the like, for example, and includes an automobile which has an internal combustion engine such as a diesel engine, a gasoline engine and the like as a power source, an electric automobile which has an electric motor as the power source, a hybrid automobile which has both the internal combustion engine and the electric motor as the power source, and the like. The electric automobile is driven by using electric power which is discharged from a cell such as a secondary cell, a hydrogen fuel cell, a metal fuel cell, an alcohol fuel cell, etc., for example.

As shown in FIG. 1, on the own vehicle M there are mounted sensors such as finders 20-1 to 20-7, radars 30-1 to 30-6, a camera 40, etc, a navigation device 50, and the vehicle control system 100.

The finders 20-1 to 20-7 is LIDAR (Light Detection and Ranging or Laser Imaging Detection and Ranging) which measures the scattered light relative to the irradiation light, for example, and finds a distance to an object. For example, the finder 20-1 is mounted on a front grill or the like, and the finders 20-2 and 20-3 are mounted on a side surface of a vehicle body, a door mirror and an interior of a headlight or around a sidelight. The finder 20-4 is mounted on a trunk lid or the like, and the finders 20-5 and 20-6 are mounted on the side surface of the vehicle, an interior of a tail light or the like. Each of the above-mentioned finders 20-1 to 20-6, for example, has a detection area of about 150 degrees with respect to the horizontal direction, for example. Moreover, the finder 20-7 is mounted on a roof or the like. The finder 20-7 has a detection area of 360 degrees with respect to the horizontal direction, for example.

The radars 30-1 and 30-4 are long range millimeter wave radars of which detection areas in the depth direction are wider than other radars. Moreover, the radars 30-2, 30-3, 30-5 and 30-6 are medium range millimeter wave radars of which detection areas in the depth direction are narrower than the radars 30-1 and 30-4.

Hereinafter, the finders 20-1 to 20-7, unless otherwise specified, are simply referred to as “finder 20”, and the radars 30-1 to 30-6, unless otherwise specified, are simply referred to as “radar 30”. The radar 30 detects an object, for example, by FM-CW (Frequency Modulated Continuous Wave) system.

The camera 40 is a digital camera which utilizes a solid state image sensing device such as CCD (Charge Coupled Device), CMOS (Complementary Metal Oxide Semiconductor) and the like, for example. The camera 40 is mounted on an upper portion of a front windshield, a back surface of a room mirror or the like. The camera 40 images the view in front of the own vehicle Min a periodically repeated manner, for example. The camera 40 may be a stereo camera which includes a plurality of cameras.

Herein, the configuration shown in FIG. 1 is only an example, so that a portion of the configuration may be omitted therefrom and another configuration may be added instead.

### First Embodiment

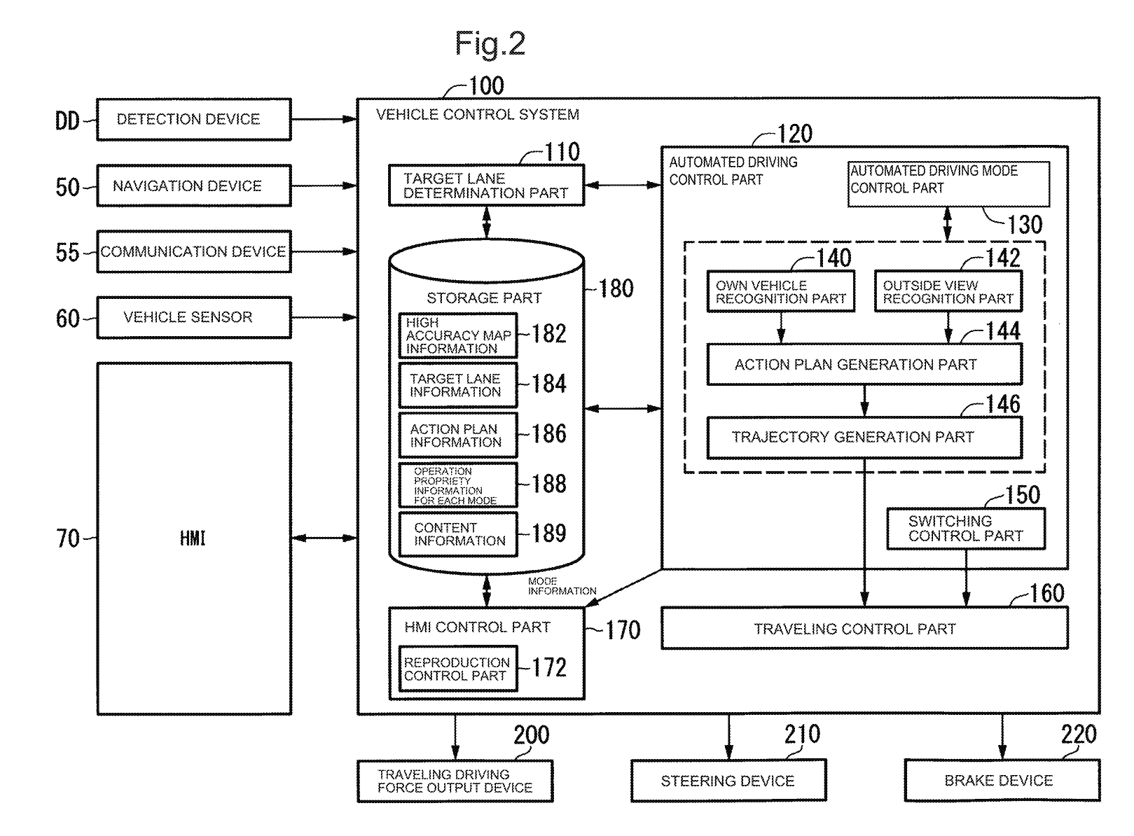

FIG. 2 is a function configuration diagram focusing on the vehicle control system 100 in accordance with a first embodiment of the present disclosure. On the own vehicle M there are mounted a detection device DD including the finder 20, the radar 30, the camera 40 and the like, a navigation device 50, a communication device 55, a vehicle sensor 60, an HMI (Human Machine Interface) 70, the vehicle control system 100, a traveling driving force output device 200, a steering device 210 and a brake device 220. These devices and equipment are connected to each other by multiple communication lines such as CAN (Controller Area Network) communication lines or the like, serial communication lines, radio communication networks, etc. By the way, the vehicle control system in claims is not limited to “the vehicle control system 100” only but may include other configuration (the detection device DD, the HMI 70, etc.) than the vehicle control system 100.

The navigation device 50 has a GNSS (Global Navigation Satellite System) receiver, map information (navigation map), a touch panel type display device functioning as a user interface, a speaker, a microphone and the like. The navigation device 50 identifies a position of the own vehicle M by the GNSS receiver and derives a route from that position to the destination designated by the user. The route derived by the navigation device 50 is provided to a target traveling lane determination part 110 of the vehicle control system 100. The position of the own vehicle M may be identified or complemented by an INS (Inertial Navigation System) which utilizes output of the vehicle sensor 60. Further, the navigation device 50 performs guidance of the route to the destination by audio or navigation display when the vehicle control system 100 executes a manual driving mode. Herein, the configuration for identifying the position of the own vehicle M may be provided independent of the navigation device 50. Moreover, the navigation device 50 maybe realized by the function of a terminal device such as a smartphone, a tablet terminal and the like held by the user, for example. In this case, the transmission and reception of the information are performed by the wireless or wire communication between the terminal device and the vehicle control system 100.

The communication device 55 performs the wireless communication utilizing for example a cellular network, Wi-Fi network, Bluetooth (registered trademark), DSRC (Dedicated Short Range Communication), etc.

The vehicle sensor 60 includes a vehicle speed sensor for detecting the vehicle speed, an acceleration sensor for detecting the acceleration, a yaw rate sensor for detecting angular velocity around a vertical axis, a direction sensor for detecting the direction of the own vehicle M, and the like.

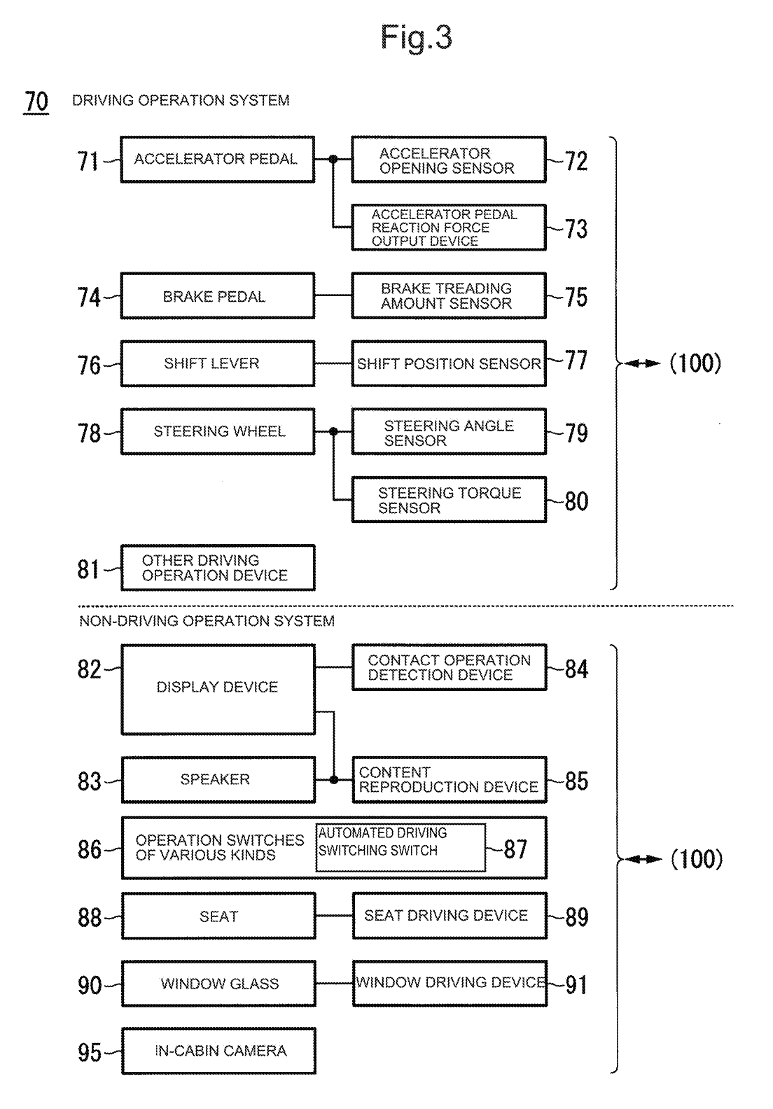

FIG. 3 is a configuration diagram of the HMI 70. The HMI 70 is provided with the configuration of a driving operation system and the configuration of a non-driving operation system, for example. The boundary between them is not clear. The configuration of the driving operation system may have the function of the non-driving operation system, and vice versa.

The HMI 70 includes, as the configuration of the driving operation system, an accelerator pedal 71, an accelerator opening sensor 72, an accelerator pedal reaction force output device 73, a brake pedal 74, a brake treading amount sensor (or master cylinder pressure sensor) 75, a shift lever 76, a shift position sensor 77, a steering wheel 78, a steering angle sensor 79, a steering torque sensor 80, and other driving operation device 81, for example.

The accelerator pedal 71 is an operation component for receiving an acceleration instruction by the vehicle occupant (or deceleration instruction by the returning operation). The accelerator opening sensor 72 detects the treading amount of the accelerator pedal 71 and outputs an accelerator opening signal indicating the treading amount to the vehicle control system 100. Herein, the signal may be outputted directly to the traveling driving force output device 200, the steering device 210 or the brake device 220, instead of being outputted to the vehicle control system 100. The same shall apply to the configuration of other driving operation system to be referred to hereunder. The accelerator reaction force output device 73 outputs force (operation reaction force) in the opposite direction to the operation direction, to the accelerator pedal 71 in accordance with the instruction, for example, from the vehicle control system 100.

The brake pedal 74 is an operation component for receiving the deceleration instruction by the vehicle occupant. The brake treading amount sensor 75 detects the treading amount (or treading force) of the brake pedal 74 and outputs a brake signal indicating a detection result, to the vehicle control system 100.

The shift lever 76 is an operation component for receiving a change instruction by the vehicle occupant of a shift stage. The shift position sensor 77 detects the shift stage instructed by the vehicle occupant and outputs a shift position signal indicating a detection result to the vehicle control system 100.

The steering wheel 78 is an operation component for receiving the instruction by the vehicle occupant of turning the steering wheel. The steering angle sensor 79 detects a steering angle of the steering wheel 78 and outputs a steering angle signal indicating a detection result, to the vehicle control system 100. The steering torque sensor 80 detects torque applied to the steering wheel 78 and outputs a steering torque signal indicating a detection result, to the vehicle control system 100.

The other driving operation device 81 is formed of, for example, a joy stick, a button, a dial switch, a GUI (Graphical User Interface) switch and the like. The other driving operation device 81 receives the acceleration instruction, the deceleration instruction, the turn instruction, etc. and outputs them to the vehicle control system 100.

The HMI 70 includes, as the configuration of the non-driving operation system, a display device (content reproduction part) 82, a speaker 83, a contact operation detection device 84, a content reproduction device 85, various kinds of operation switches 86, a seat 88, a seat operation device 89, a window glass 90, a window driving device 91 and an in-cabin camera 95, for example.

The display device 82 is an LCD (Liquid Crystal Display), an organic EL (electroluminescence) display device or the like to be mounted on each portion of an instrument panel, optional locations or the like facing toward the passenger seat or rear seat. In addition, the display device 82 may be an HUD (Head Up Display) which projects the image on a front windshield or other windows. The speaker 83 outputs a voice. The contact operation detection device 84 detects a contact position (touch position) of a display screen of the display device 82 thereby to output it to the vehicle control system 100 in the case where the display device 82 is a touch panel. Herein, when the display device 82 is not the touch panel, the contact operation detection device 84 may be omitted.

The content reproduction device 85 includes a DVD (Digital Versatile Disc) reproduction device, a CD (Compact Disc) reproduction device, a television receiver, a generation device of various kinds of guide images and the like, for example. Some or all of the display device 82, the speaker 83, the contact operation detection device 84 and the content reproduction device 85 may be formed in the configuration which is in common with the navigation device 50.

The various kinds of operation switches 86 are arranged in optional locations within an interior of the vehicle. An automated driving switching switch 87 which instructs a start (or start in the future) and stop of the automated driving is included in the various kinds of operation switches 86. The automated driving switching switch 87 may be any of a GUI (Graphical User Interface) switch and a mechanical switch. Further, the various kinds of operation switches 86 may include switches for driving a seat operation device 89 and a window operation device 91.

The seat 88 is a seat on which the vehicle occupant is seated. The seat operation device 89 operates freely a reclining angle, a position in the forward and rearward direction, a yaw angle, etc. of the seat 88. The window glass 90 is provided in each of doors, for example. The window operation device 91 operates an opening and closing of the window glass 90.

The in-cabin camera 95 is the digital camera utilizing the solid state image sensing device such as the CCD, the CMOS and the like. The in-cabin camera 95 is mounted in a position in which at least a head of the vehicle occupant who performs the driving operation can be imaged, such as a rear-view mirror, a steering boss part, the instrument panel and the like. The camera 40 images the vehicle occupant, for example, in a periodically repeated manner.

Prior to the explanation of the vehicle control system 100, the traveling driving force output device 200, the steering device 210 and the brake device 220 will be explained.

The traveling driving force output device 200 outputs traveling driving force (torque) for traveling the vehicle, to driving wheels. The traveling driving force output device 200 is provided with the engine, a transmission and an engine ECU (Electronic Control Unit) for controlling the engine in the case where the own vehicle M has the internal combustion engine as the power source. Similarly, it is provided with a traveling motor and a motor ECU for controlling the traveling motor in the case where the own vehicle M is an electric vehicle having an electric motor as the power source, and provided with the engine, the transmission, the engine ECU, the traveling motor and the motor ECU in the case where the own vehicle M is the hybrid automobile, for example. When the traveling driving force output device 200 has only the engine, the engine ECU adjusts a throttle opening of the engine, the shift stage and the like in accordance with information inputted from a traveling control part 160 to be referred to later. When the traveling driving force output device 200 has only the traveling motor, the motor ECU adjusts a duty ratio of the PWM signal given to the traveling motor in accordance with the information inputted to the traveling control part 160. When the traveling driving force output device 200 has the engine and the traveling motor, the engine ECU and the motor ECU control the traveling driving force in cooperation with each other in accordance with the information inputted from the traveling control part 160.

The steering device 210 is provided with a steering ECU and an electric motor, for example. The electric motor changes the direction of a turning wheel by acting force on a rack and pinion mechanism, for example. The steering ECU operates the electric motor in accordance with the information inputted from the vehicle control system 100 or the information of the inputted steering angle or the steering torque thereby to change the direction of the turning wheel.

The brake device 220 is an electric servo brake device which is provided with a brake caliper, a cylinder for transmitting oil pressure to the brake caliper, an electric motor for generating the oil pressure in the cylinder, and a braking control part, for example. The braking control part of the electric servo brake device controls the electric motor in accordance with the information inputted from the traveling control part 160 so as to output the brake torque in response to the braking operation, to each of the wheels. The electric servo brake device may be provided as a backup with a mechanism which transmits the oil pressure generated by the operation of the brake pedal, to the cylinder through a master cylinder. Herein, the brake device 220 is not limited to the above-mentioned electric servo brake device but may be an electronic control type hydraulic brake device. The electronic control type hydraulic brake device controls an actuator in accordance with the information inputted from the traveling control part 160 thereby to transmit the oil pressure of the master cylinder to the cylinder. Further, the brake device 220 may include a regenerative brake device by the traveling motor which may be included in the traveling driving force output device 200.

### [Vehicle Control System]

The vehicle control system 100 will be explained hereunder. The vehicle control system 100 is realized by one or more processors or hardware which has an equivalent function thereto, for example. The vehicle control system 100 may be composed of a combination of the processor such as a CPU (Central Processing Unit) or the like, a memory system, the ECU (Electronic Control Unit) to which the communication interface is connected through an internal bus, an MPU (Micro-Processing Unit), etc.

Referring again to FIG. 2, the vehicle control system 100 is provided with the target traveling lane determination part 110, an automated driving control part 120, the traveling control part 160, an HMI control part 170 and a storage part 180, for example. The automated driving control part 120 is provided with an automated driving mode control part 130, an own vehicle recognition part 140, an outside view recognition part 142, an action plan generation part 144, a trajectory generation part 146 and a switching control part 150, for example. The target traveling lane determination part 110, each part of the automated driving control part 120, and a part or the whole of the traveling control part 160 are realized at the time when the processors execute programs (software). Further, a part or the whole of these may be realized by hardware such as an LSI (Large Scale Integration), an ASIC (Application Specific Integrated Circuit) and the like and may be realized by a combination of the software and the hardware.

In the storage part 180 there are stored high accuracy map information 182, target traveling lane information 184, action plan information 186, operation propriety information 188 for each mode, content information 189, etc., for example. The storage part 180 is realized by an ROM (Read Only Memory), an RAM (Random Access Memory), an HDD (Hard Disk Drive), a flash memory and the like. A program executed by the processor may be stored in the storage part 180 in advance and may be downloaded from an external device through on-vehicle internet equipment, etc. In addition, the program may be installed in the storage part 180 when a portable storage medium which stores the program is installed in a drive device (not shown). Further, the on-vehicle computer of the vehicle control system 100 may be decentralized into a plurality of computer devices.

The target traveling lane determination part 110 is realized by the MPU, for example. The target traveling lane determination part 110 divides the route provided from the navigation device 50, into a plurality of blocks (for example, the route is divided at intervals of 100 [m] in the traveling direction of the vehicle) and determines the target traveling lane for each of the blocks by referring to the high accuracy map information 182. The target traveling lane determination part 110 determines what traveling lane in the order from the left to be traveled, for example. In the case where a branch point and a junction exist in the route, the target traveling lane determination part 110 determines a target traveling lane in such a manner as to allow the own vehicle M to be traveled along the rational traveling route for moving toward the branch of destination, for example. The target traveling lane determined by the target traveling lane determination part 110 is stored in the storage part 180 as the target traveling lane information 184.

The high accuracy map information 182 is map information which is higher in accuracy than a navigation map of the navigation device 50. The high accuracy map information 182 includes the information of a center of the traveling lane or the information of a boundary of the traveling lane, for example. Further, road information, traffic regulation information, address information (address, postal code), facility information, telephone number information and the like may be included in the high accuracy map information 182. In the road information there are included information which indicates a classification of the road such as a superhighway, a paying motorway, a national road and a prefectural road, the number of traveling lanes of the road, a width of each traveling lane, an inclination of the road, a position of the road (three-dimensional coordinates including longitude, latitude and height), a curvature of a curve of the traveling lane, positions of the junction and the branch point of the traveling lane, a mark or sign provided in the road, and the like. In the traffic regulation information there is included the information that the traveling lane is blocked due to a construction, a traffic accident, a traffic jam, etc.

The automated driving mode control part 130 determines the mode of the automated driving to be executed by the automated driving control part 120. The modes of the automated driving in this embodiment include the following modes. Herein, the following modes are only examples and the number of modes of the automated driving may be freely determined.

### [Mode A]

The mode A is a mode of the highest degree of automated driving. When the mode A is executed, all the vehicle control such as complicated merging control, etc. is automatically performed, so that the vehicle occupant is not required to monitor the surroundings and the condition of the own vehicle M.

### [Mode B]

The mode B is a mode of higher degree of the automated driving to be ranked next to the mode A. When the mode B is executed, in principle, although all the vehicle control is automatically performed, the driving operation of the own vehicle M is entrusted to the vehicle occupant as the need arises. Therefore, the vehicle occupant is required to monitor the surroundings and the condition of the own vehicle M.

### [Mode C]

The mode C is a mode of high degree of the automated driving to be ranked next to the mode B. When the mode C is executed, the vehicle occupant is required to perform confirming operation according to scenes, in relation to the HMI 70. In the mode C, for example, in the case where the timing of the traveling lane change is communicated to the vehicle occupant and the vehicle occupant performs the operation for instructing the HMI 70 on the traveling lane change, the automatic traveling lane change is performed. Therefore, the vehicle occupant is required to monitor the surroundings and the condition of the own vehicle M.

The automated driving control part 130 determines the mode of the automated driving based on the operation of the vehicle occupant relative to the HMI 70, an event determined by the action plan generation part 144, a traveling mode determined by the trajectory generation part 146, etc. The mode of the automated driving is communicated to the HMI control part 170. Further, the limit corresponding to the performance of the detection device DD of the own vehicle M maybe set up with respect to the mode of the automated driving. For example, when the detection device DD is low in performance, it is possible to set up such that the mode A is not executed. In any of these modes, it is possible to switch the mode to the manual driving mode (override) by the operation relative to the configuration of the driving operation system in the HMI 70.

The own vehicle position recognition part 140 of the automated driving control part 120 recognizes the traveling lane in which the own vehicle M travels (traveling lane) and the relative position of the own vehicle M with respect to the traveling lane based on the high accuracy map information 182 stored in the storage part 180 and the information inputted from the finder 20, the radar 30, the camera 40, the navigation device 50 or the vehicle sensor 60.

The own vehicle recognition part 140 recognizes the traveling lane by comparing a pattern (for example, arrangement of solid lines and broken lines) of road division lines recognized from the high accuracy map information 182 and a pattern of the road division lines around the own vehicle M recognized from the image imaged by the camera 40, for example. In this recognition, it is possible to take into account the position of the own vehicle M obtained from the navigation device 50 and the processing result by the INS.

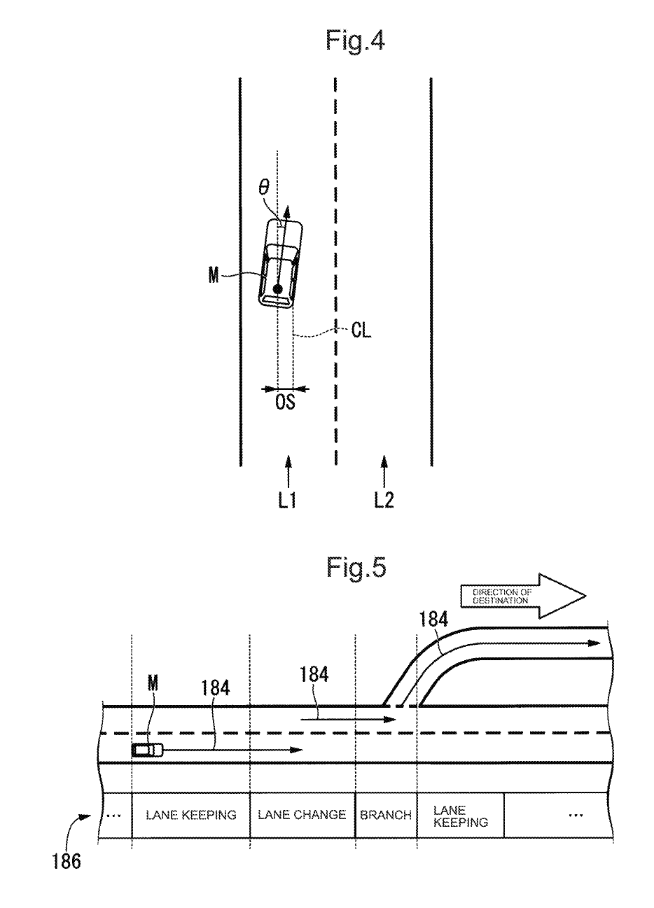

FIG. 4 is a diagram showing a state in which the relative position of the own vehicle M with respect to a traveling lane L1 is recognized by an own vehicle position recognition part 140. The own vehicle recognition part 140 recognizes a deviation OS of a reference point (for example, center of gravity) of the own vehicle M from a center CL of the traveling lane and an angle 8 of the traveling direction of the own vehicle M to a line of the center CL of the traveling lane, as the relative position of the own vehicle M with respect to the traveling lane L1, for example. Herein, alternatively, the own vehicle position recognition part 140 may recognize the position of the reference point of the own vehicle M with respect to either of side end portions of the traveling lane L1, etc. as the relative position of the own vehicle M with respect to the traveling lane. The relative position of the own vehicle M recognized by the own vehicle position recognition part 140 is provided to the target traveling lane determination part 110.

The outside view recognition part 142 recognizes the condition of the position, the speed, the acceleration and the like of the peripheral vehicle, based on the information inputted from the finder 20, the radar 30, the camera 40, etc. The peripheral vehicle designates the traveling vehicle around the own vehicle M and the vehicle which travels in the same direction as the own vehicle M, for example. The position of the peripheral vehicle maybe indicated by representative points of the center of gravity, corners or the like of the other vehicle and may be indicated by a region represented by contours of the other vehicle. “The condition” of the peripheral vehicle may include the acceleration of the peripheral vehicle and whether or not the traveling lane is changed (or whether or not the traveling lane is about to be changed), which are grasped based on the information of the above various devices. Further, the outside view recognition part 142 may recognize the positions of a guardrail, a utility pole, a parked vehicle, a pedestrian, and other objects in addition to the peripheral vehicles.

The action plan generation part 144 is configured to set up a start point of the own vehicle M and/or a destination of the automated driving. The start point of the automated driving may be a present position of the own vehicle M and may be a point at which the operation instructing the automated driving has been executed. The action plan generation part 144 generates the action plan with respect to a section between the start point and the destination of the automated driving. Herein, the action plan generation part 144 may generates the action plan with respect to an optional section, without being limited to the above section.

The action plan is composed of a plurality of events which are executed successively, for example. In the events there are included a deceleration event for decelerating the own vehicle M, an acceleration event for accelerating the own vehicle M, a lane keeping event for allowing the own vehicle M to travel without deviating from the traveling lane, a traveling lane change event for changing the traveling lane, a passing event for allowing the own vehicle M to pass a vehicle which travels ahead, a branch event for changing the traveling lane to a desired traveling lane at the branch point and allowing the own vehicle M to travel without deviating from the present traveling lane, a junction event for accelerating and decelerating the own vehicle M in a junction traveling lane for merging into a main lane, so as to change the traveling lane, a handover event for switching from the manual driving mode to the automated driving mode at the start point of the automated driving and switching from the automated driving mode to the manual driving mode at a predetermined end point of the automated driving, etc., for example. The action plan generation part 144 sets up the traveling lane change event, the branch event or the junction event at a point at which the target traveling lane determined by the target traveling lane determination part 110 is switched. The information indicating the action plan generated by the action plan generation part 144 is stored in the storage part 180 as the action plan information 186.

FIG. 5 is a diagram showing an example of the action plan generated for a certain section. As shown in the drawing, the action plan generation part 144 generates the action plan for allowing the own vehicle M to travel along the target travel lane indicated by the target travel lane information 184. Herein, in spite of the target traveling lane information 184, the action plan generation part 144 may change dynamically the action plan according to the change of the condition of the own vehicle M. For example, the action plan generation part 144 changes the event which is set up in the operation section in which the own vehicle M is scheduled to travel, in the case where the speed of the peripheral vehicle recognized by the outside view recognition part 142 during the traveling of the vehicle exceeds the threshold value or where the moving direction of the peripheral vehicle which travels the traveling lane contiguous to the own traveling lane turns to the direction of the own traveling lane. For example, in the case where the traveling lane change event is set up so as to be executed after the lane keeping event, when it is confirmed by the recognition result of the outside view recognition part 142 that, during the lane keeping event, the vehicle has come at the speed more than the threshold value from the rearward direction of the traveling lane to which the traveling lane change is scheduled, the action plan generation part 144 may change the next event of the lane keeping event from the traveling lane change event to the deceleration event or the lane keeping event or the like. As a result, the vehicle control system 100 allows the own vehicle M to automatically travel safely also when the condition of the outside view is changed.

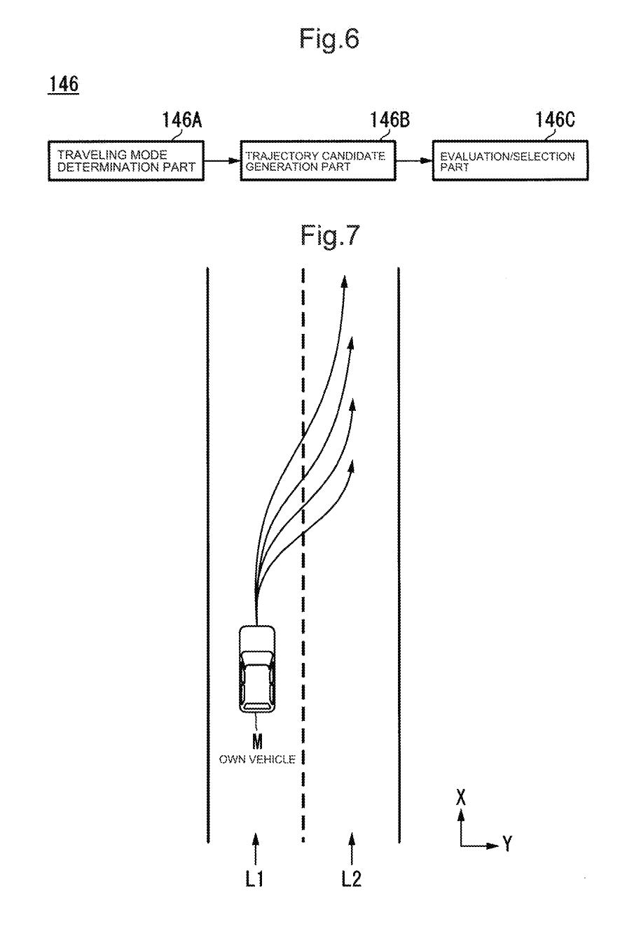

FIG. 6 is a diagram showing an example of a configuration of the trajectory generation part 146. The trajectory generation part 146 is provided with a traveling mode determination part 146A, a trajectory candidate generation part 146B and an evaluation and selection part 146C, for example.

The traveling mode determination part 146A determines any of constant-speed traveling, follow-up traveling, low-speed follow-up traveling, deceleration traveling, curve traveling, obstacle avoiding traveling, etc., when the lane keeping event is executed, for example. In this case, the traveling mode determination part 146A determines the traveling mode to be the constant-speed traveling when the other vehicle does not exist in front of the own vehicle M. Moreover, the traveling mode determination part 146A determines the traveling mode to be the follow-up traveling when the follow-up traveling is performed with respect to the preceding vehicle which travels ahead of the own vehicle M. Similarly, the traveling mode determination part 146A determines the traveling mode to be the low-speed follow-up traveling in the case of the traffic jam or the like. Further, the traveling mode determination part 146A determines the traveling mode to be the deceleration traveling when the deceleration of the preceding vehicle is recognized by the outside view recognition part 142, or when the event such as the stopping of the vehicle, the parking of the vehicle or the like is executed. Further, the traveling mode determination part 146A determines the traveling mode to be the curve traveling when the outside view recognition part 142 has recognized that the own vehicle M entered the curved road. Further, the traveling mode determination part 146A determines the traveling mode to be the obstacle avoiding traveling when the obstacle has been recognized in front of the own vehicle M by the outside view recognition part 142. In addition, in the case where the traveling lane change event, the passing event, the branch event, the junction event, the handover event, etc. are executed, the traveling mode determination part 146A determines the traveling mode in accordance with each of these events.

The trajectory candidate generation part 146B generates the candidate of the trajectory based on the traveling mode determined by the traveling mode determination part 146A. FIG. 7 is a diagram showing an example of the candidate of the trajectory generated by the trajectory candidate generation part 146B. FIG. 7 indicates the candidate of the trajectory which is generated in the case where the own vehicle M changes the traveling lane from the traveling lane L1 to the traveling lane L2.

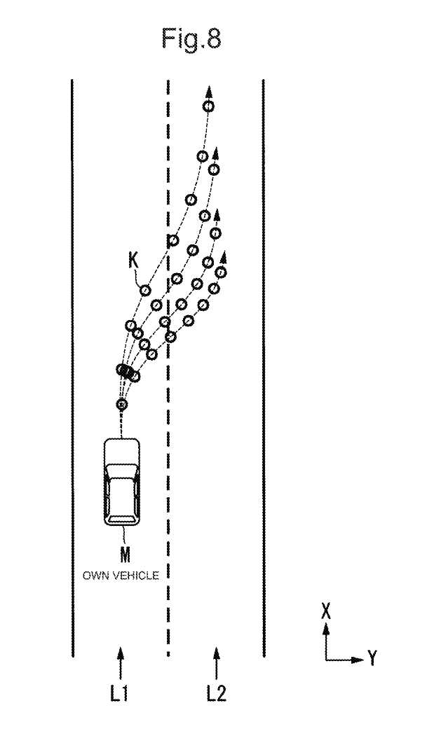

The trajectory candidate generation part 146B determines the trajectories as indicated in FIG. 7 to be a group of target positions (trajectory points K) that the reference position (for example, the center of gravity or a center of a rear wheel shaft) of the own vehicle M should reach at every prescribed time interval in the future, for example. FIG. 8 is a diagram representing, by the trajectory points K, the examples of the trajectory candidates generated by the trajectory candidate generation part 146B. The speed of the own vehicle M becomes faster as a space between the trajectory points K is wider, and the speed of the own vehicle M becomes slower as the space between the trajectory points K is narrower. Accordingly, the trajectory candidate generation part 146B widens the space between the trajectory points K gradually in the case of acceleration and narrows the space between the trajectory points gradually in the case of deceleration.

Like this, since the trajectory point K includes a speed component, the trajectory candidate generation part 146B is required to give the target speed to each of the trajectory points K. The target speed is determined according to the traveling mode which is determined by the traveling mode determination part 146A.

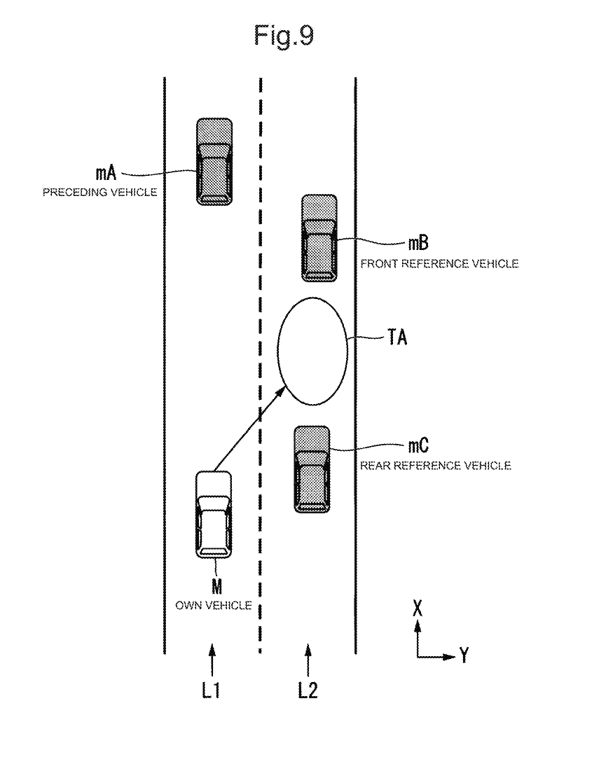

Herein, the determination method of the target speed in the case of performing the change of the traveling lane (including the branch) will be explained. First, the trajectory candidate generation part 146B sets up a target position of the traveling lane change (or a junction target position). The traveling lane change target position is set up as a relative position with respect to the peripheral vehicle, and “the space between the peripheral vehicles to perform the traveling lane change” is determined. The trajectory candidate generation part 146B focuses on three peripheral vehicles with reference to the traveling lane change target position and determines the target speed in the case of changing the traveling lane. FIG. 9 is a diagram showing a traveling lane change target position TA. In the drawing, L1 designates the own traveling lane, and the L2 designates the neighboring traveling lane. The peripheral vehicle which travels just in front of the own vehicle M in the same traveling lane as the own vehicle M is defined as a preceding vehicle mA, the peripheral vehicle which travels just in front of the traveling lane change target position TA is defined as a front reference vehicle mB, and the peripheral vehicle which travels just behind the traveling lane change target position TA is defined as a rear reference vehicle mC. Although the own vehicle M is required to perform acceleration and deceleration in order to move up to the lateral side of the traveling lane change target position TA, it has to avoid catching up with the preceding vehicle mA at that time. Therefore, the trajectory candidate generation part 146B forecasts the condition in the future of the three peripheral vehicles, whereby to determine the target speed so as to prevent interference with each of the peripheral vehicles.

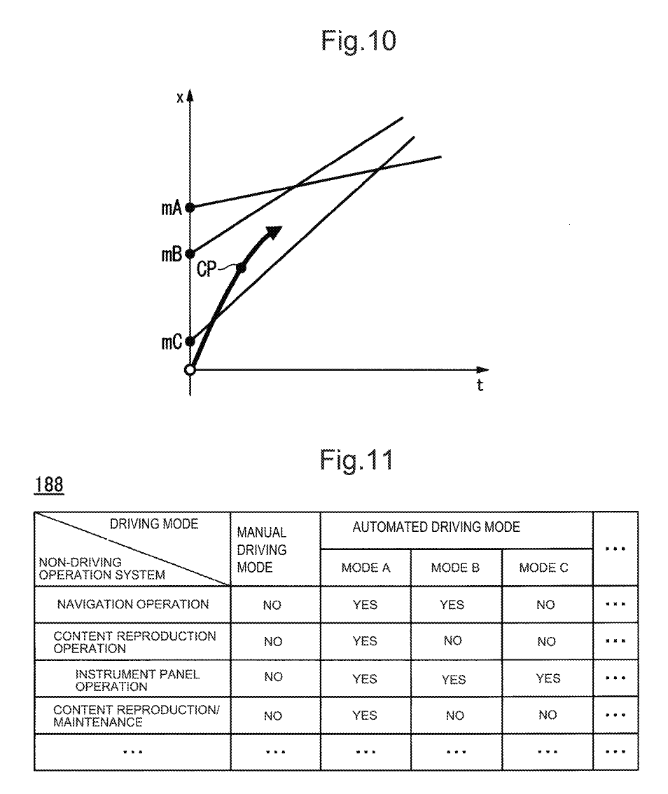

FIG. 10 is a diagram showing a speed generation model when assuming that the speeds of the three peripheral vehicles are constant. In the drawing, straight lines extending from mA, mB and mC designate displacement in the traveling direction when assuming that each of the peripheral vehicles travels at a constant speed. The own vehicle M, at a point CP at which the traveling lane change is completed, is located between the front reference vehicle mB and the rear reference vehicle mC and has to be located behind the preceding vehicle mA before that point. Under such a restriction, the trajectory candidate generation part 146B derives a plurality of time-series patterns of the target speeds before the travel lane change is completed. Then, when the time-series patterns of the target speeds are applied to models such as spline curves or the like, the plurality of trajectory candidates as shown in FIG. 8 are derived. Herein, the operation patterns of the three peripheral vehicles are not limited to the constant speeds as shown in FIG. 10 but may be forecasted based on constant acceleration and a constant jerk (jerk degree).

The evaluation and selection part 146C evaluates the trajectory candidate generated by the trajectory candidate generation part 146B, for example, from two viewpoints of planning and safety, and selects the trajectory to be outputted to the traveling control part 160. From the viewpoint of the planning, for example, the followability to the previously generated plan (for example, action plan) is high, and the trajectory is evaluated at a high level when the overall length of the trajectory is short. For example, in the case where the travel lane change in the right direction is desired, the trajectory configured such that the traveling lane is once changed in the left direction and returned is low in evaluation. From the viewpoint of the safety, for example, the evaluation is high as the distance between the own vehicle M and the object (peripheral vehicle, etc.) is long and the change amount of the acceleration/deceleration speed or the steering angle or the like decreases in each of the trajectory points.

The switching control part 50 switches the automated driving mode and the manual driving mode to each other based on the signal inputted from the automated driving switching switch 87. Moreover, the switching control part 150 switches the automated driving mode to the manual driving mode based on the operation instructing the acceleration, the deceleration or the steering with respect to the configuration of the driving operation system of the HMI 70. For example, the switching control part 150 switches the automated driving mode to the manual driving mode (override) in the case where the condition in which the operation amount indicated by the signal inputted from the configuration of the driving operation system of the HMI 70 exceeds the threshold value continues more than the reference time. Further, the switching control part 150 may be configured to perform a return to the automated driving mode in the case where the operation with respect to the configuration of the driving operation system of the HMI 70 has not been detected during the predetermined time after switching to the manual driving mode due to the override.

The traveling control part 160 controls the traveling driving force output device 200, the steering device 210 and the brake device 220 in such a manner that the own vehicle M passes through the trajectory generated by the trajectory generation part 146 in accordance with the scheduled time.

The HMI control part 170 refers to the operation propriety information 188 for each mode and controls the HMI 70 according to the classification of the automated driving, when the information of the mode for the automated driving is communicated by the automated driving control part 120. Further, the HMI control part 170 is provided with a reproduction control part 172 which controls the reproduction of various kinds of contents in the display device 82 according to the automated driving mode inputted from the automated driving mode control part 130.

FIG. 11 is diagram showing an example of the operation propriety information 188 for each mode. The operation propriety information 188 for each mode shown in FIG. 11 has “the manual driving mode” and “the automated driving mode” as an item of the automated driving. Moreover, it has the above-mentioned “mode A”, “mode B”, “mode C”, and the like as “the automated driving mode”. Further, the operation propriety information 188 for each mode has, as an item of the non-driving operation system, “navigation operation” which is the operation relative to the navigation device 50, “content reproduction operation” which is the operation relative to the content reproduction device 85, “instrument panel operation” which is the operation relative to the display device 82, and the like. Further, the operation propriety information 188 for each mode has “content reproduction and maintenance” which indicates the propriety of the content reproduction on the display device 82, and the like, for example. In the example of the operation propriety information 188 for each mode as shown in FIG. 11, although the propriety of operation of the vehicle occupant relative to the non-driving operation system for each of the above-mentioned driving modes is set up, the targeted interface device is not limited to that.

The HMI control part 170 judges the device allowed to be used (the navigation device 50, a part or the whole of the HMI 70) and the device not allowed to be used, by referring to the operation propriety information 188 for each mode based on the information of the modes obtained from the automated driving control part 120. Further, the HMI control part 170 controls, based on the result of judgment, the propriety of the reception as to the operation of the vehicle occupant relative to the HMI 70 or the navigation device 50 of the non-driving operation system.

For example, when the driving mode executed by the vehicle control system 100 is the manual driving mode, the vehicle occupant operates the driving operation system (for example, the accelerator pedal 71, the brake pedal 74, the shift lever 76 and the steering wheel 78 or the like) of the HMI 70. Moreover, when the driving mode executed by the vehicle control system 100 is the mode B or the mode C or the like of the automated driving mode, the vehicle occupant is responsible for monitor the surroundings of the own vehicle M. In such a case, in order to prevent attention of the vehicle occupant from becoming distracted (driver distraction) by the action (for example, the operation of the HMI 70, etc.) other than the driving, the HMI control part 170 performs such a control that the operation relative to a part or the whole of the non-driving operation system of the HMI 70 is not received. The condition where such control has been performed is designated as “distraction restricted condition”. At that time, the HMI control part 170, in order to monitor the surroundings of the own vehicle M, allows the display device 82 to display as an image or the like the existence of the peripheral vehicle around the own vehicle M recognized by the outside view recognition part 142 and the condition of the peripheral vehicle and may allow the HMI 70 to receive the confirming operation according to the scenes during the traveling of the own vehicle M.

Further, the HMI control part 170 relaxes the control of the driver distraction and performs control for receiving the operation of the vehicle occupant relative to the non-driving operation system of which the operation has not been received, when the driving mode is the mode A of the automated driving. For example, the HMI control part 170 allows the display device 82 to display the video image, allows the speaker 83 to output the audio, and allows the content reproduction device 85 to reproduce the contents from the DVD, etc. Herein, in the contents to be reproduced by the content reproduction device 85 there maybe included various kinds of contents concerning an amusement and an entertainment of the television program, etc. other than the contents stored in the DVD, etc., for example. Further, “the content reproduction operation” shown in FIG. 11 may designate the operation of the contents concerning such amusement and entertainment.

### [Content Display Control]

The vehicle control system 100 according to this embodiment has a function of controlling the reproduction of the contents on the display device, based on the condition of the vehicle which executes the automated driving. For example, the vehicle control system 100 according to this embodiment has a function of stopping the reproduction of the contents when having switched over to the automated driving mode in which the reproduction of the contents is not permitted, after starting the reproduction of the contents, and, thereafter, automatically resuming the reproduction of the contents when having switched to the automated driving mode in which the reproduction of the contents is permitted (when the restrictions of the content reproduction is released).

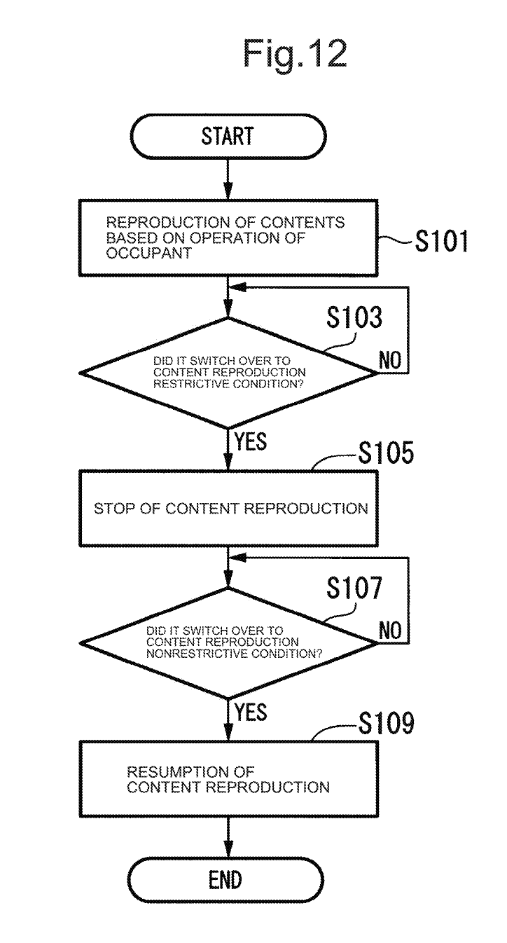

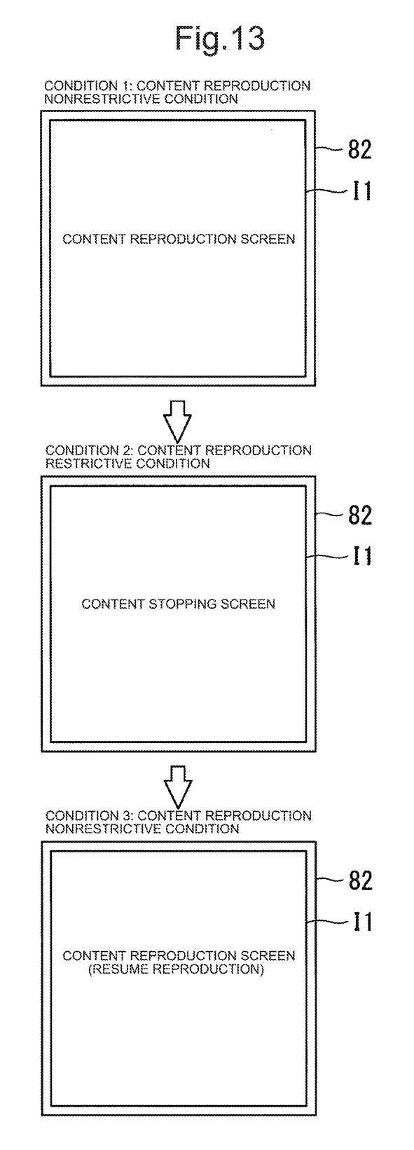

The operation or functioning according to this embodiment, for allowing the contents based on the operation of the vehicle occupant to be displayed on the display device 82 will be explained hereunder. FIG. 12 is a flowchart showing an example of reproduction control processing of contents in accordance with this embodiment. FIG. 13 is a diagram showing an example of screen control of the display device 82 in accordance with the first embodiment.

First, in the condition where the content reproduction operation is permitted (for example, the condition where the own vehicle M is stopped or the condition where the vehicle is in the automated driving mode in which the content reproduction operation is permitted), the reproduction control part 172 receives the operation of the content reproduction device 85 by the vehicle occupant and reproduces the desired contents according to the operation of the vehicle occupant on the screen I1 of the display device 82 (Step S101). For example, the reproduction control part 172 receives the operation of the DVD reproduction device by the vehicle occupant or the operation of the content reproduction device 85 which is the television receiver, and reproduces the video image content, etc. corresponding to the received operation on the display device 82. The automated driving mode in which the content reproduction operation is permitted is the automated driving mode (mode A) in the operation propriety information 188 for each mode of FIG. 11, for example. Thus, as shown in “the condition 1: content reproduction nonrestrictive condition” of FIG. 13, the contents based on the operation of the vehicle occupant are reproduced on the screen I1 of the display device 82.

Next, the reproduction control part 172 refers to the mode information inputted from the automated driving mode control part 130 and the operation propriety information 188 for each mode stored in the storage part 180 and judges whether or not the own vehicle M was switched over to the content reproduction restrictive condition (Step S103). For example, in the case where the mode information inputted from the automated driving control part 130 is the automated driving mode (mode B or C) in which the content reproduction is not permitted in the operation propriety information 188 for each mode shown in FIG. 11, the reproduction control part 172 judges it to have been switched over to the content reproduction restrictive condition. On the other hand, in the case where the mode information inputted from the automated driving control part 130 is the automated driving mode (mode A) in which the content reproduction is permitted in the operation propriety information 188 for each mode shown in FIG. 11, the reproduction control part 172 judges it not to be switched over to the content reproduction restrictive condition thereby to continue the monitoring of the automated driving mode.

Next, in the case where the reproduction control part 172 judges it to have been switched over to the content reproduction restrictive condition, it stops the reproduction of the contents on the display device 82 (Step S105). Consequently, as shown in “the condition 2: content reproduction restrictive condition” of FIG. 13, a still picture (stationary screen) of the contents is displayed on the screen I1. Herein, during the time this still picture is displayed, it is possible to reproduce only the audio of the contents.

Next, the reproduction control part 172 refers to the mode information inputted from the automated driving mode control part 130 and the operation propriety information 188 for each mode stored in the storage part 180 and judges whether or not the own vehicle M was switched over to the content reproduction nonrestrictive condition (Step S107). For example, in the case where the mode information inputted from the automated driving control part 130 is the automated driving mode (mode A) in which the content reproduction is permitted in the operation propriety information 188 for each mode shown in FIG. 11, the reproduction control part 172 judges it to have been switched over to the content reproduction nonrestrictive condition. On the other hand, in the case where the mode information inputted from the automated driving control part 130 is the automated driving mode (mode B or C) in which the content reproduction is not permitted in the operation propriety information 188 for each mode shown in FIG. 11, the reproduction control part 172 judges it not to be switched over to the content reproduction nonrestrictive condition thereby to continue the monitoring of the automated driving mode.

Next, when the reproduction control part 172 judges it to have been switched over to the content reproduction nonrestrictive condition, it resumes the reproduction of the contents on the display device 82 and ends the processing of this flow chart (Step S109). Consequently, as shown in “the condition 3: content reproduction nonrestrictive condition” of FIG. 13, the contents are automatically reproduced on the screen I1. Herein, when the contents are the video image contents stored in the DVD, the reproduction may be resumed from the stop point of the contents in the above step S105.

According to the above embodiment, when the automated driving mode of the own vehicle M has been switched over from the content reproduction restrictive condition to the content reproduction nonrestrictive condition, the reproduction of the contents is automatically resumed, so that the vehicle occupant is not required to operate the content reproduction device at the time of resuming the reproduction of the contents. Therefore, it is possible to ensure the safety and to improve the convenience of the content reproduction device in the case of executing the automated driving.

### Second Embodiment

The second embodiment will be explained hereunder. The vehicle control system according to the second embodiment may employ the same configuration as the configuration of the vehicle control system 100 which is explained in the above-mentioned first embodiment. Therefore, in the following explanation, parts similar to the first embodiment are given like reference characters, and the explanation will be omitted or simplified.

As compared with the first embodiment, the second embodiment is different in that the contents to be reproduced during the stopping period of the reproduction of the contents are stored in the storage part 180 in the case where the contents such as the television video image and the like distributed by the broadcast are displayed on the display device 82, and, at the time the reproduction of the contents is resumed, the contents stored in the storage part 180 are read out and reproduced. Herein, the contents distributed by the broadcast are the contents which are distributed simultaneously to a plurality of systems by using the same carrier (electric wave) and are different from the contents which are distributed by an on-demand method in response to the demand of users.

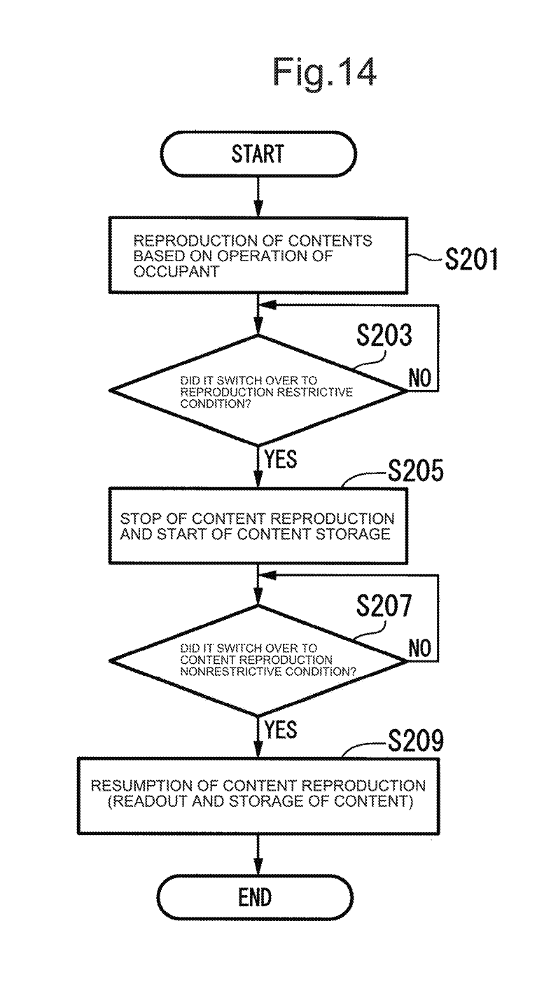

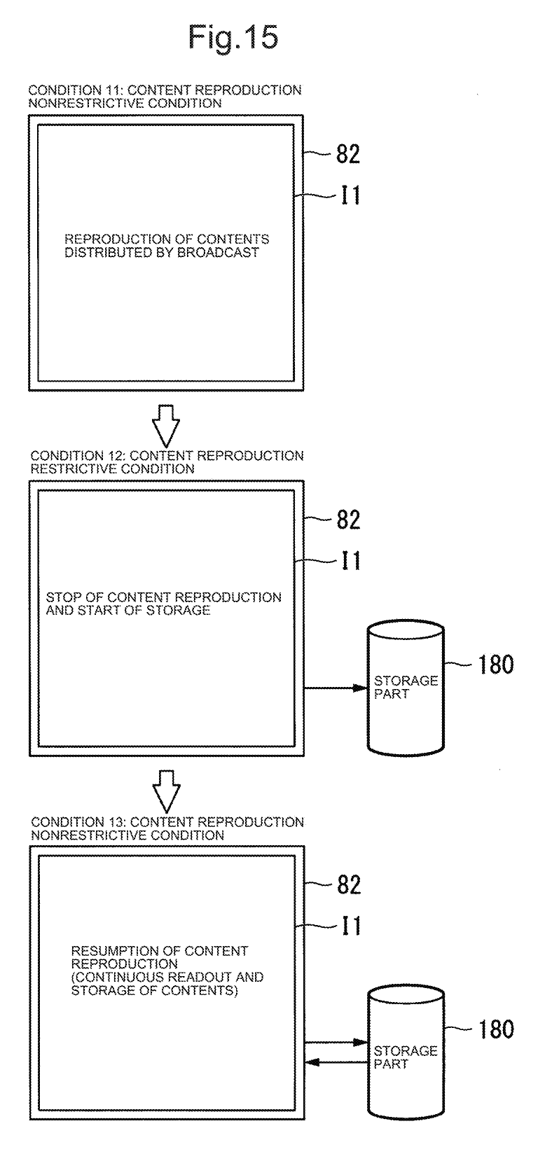

The operation or functioning in this embodiment for reproducing the contents based on the operation of the vehicle occupant on the display device 82 will be explained hereunder. FIG. 14 is a flow chart showing an example of the reproduction control processing of the contents in accordance with this embodiment. FIG. 15 is a diagram showing an example of the screen control of the display device 82 in accordance with this embodiment.

First, in the condition where the content reproduction operation is permitted (for example, the condition where the own vehicle M is stopped or the condition where the vehicle is in the automated driving mode in which the content reproduction operation is permitted), the reproduction control part 172 receives the operation of the content reproduction device 85 by the vehicle occupant and reproduces the desired contents according to the operation of the vehicle occupant on the screen I1 of the display device 82 (Step S201). For example, the reproduction control part 172 receives the operation by the vehicle occupant of the content reproduction device 85 which is the television receiver and reproduces the television video image or the like on the display device 82. In this way, as shown in “the condition 11: content reproduction nonrestrictive condition” of FIG. 15, the contents are reproduced on the screen I1 of the display device 82.

Next, the reproduction control part 172 refers to the mode information inputted from the automated driving mode control part 130 and the operation propriety information 188 for each mode stored in the storage part 180 and judges whether or not the own vehicle M was switched over to the content reproduction restrictive condition (Step S203). For example, in the case where the mode information inputted from the automated driving control part 130 is the automated driving mode (mode B or C) in which the content reproduction is not permitted in the operation propriety information 188 for each mode shown in FIG. 11, the reproduction control part 172 judges it to have been switched over to the content reproduction restrictive condition. On the other hand, in the case where the mode information inputted from the automated driving control part 130 is the automated driving mode (mode A) in which the content reproduction is permitted in the operation propriety information 188 for each mode shown in FIG. 11, the reproduction control part 172 judges it not to be switched over to the content reproduction restrictive condition thereby to continue the monitoring of the automated driving mode.

Next, in the case where the reproduction control part 172 judges it to have been switched over to the content reproduction restrictive condition, it stops the reproduction of the contents on the display device 82 and starts the storage of the contents (for example, the contents received by the television receiver during the stopping period) to be reproduced during the stopping period (Step 205). The contents to be reproduced during this stopping period are stored in the storage part 180 as the content information 189. Consequently, as shown in “the condition 12: content reproduction restrictive condition” of FIG. 15, the still picture (stationary screen) of the contents is displayed on the screen I1.

Next, the reproduction control part 172 refers to the mode information inputted from the automated driving mode control part 130 and the operation propriety information 188 for each mode stored in the storage part 180 and judges whether or not the own vehicle M was switched over to the content reproduction nonrestrictive condition (Step S207). For example, in the case where the mode information inputted from the automated driving control part 130 is the automated driving mode (mode A) in which the content reproduction is permitted in the operation propriety information 188 for each mode shown in FIG. 11, the reproduction control part 172 judges it to have been switched over to the content reproduction nonrestrictive condition. On the other hand, in the case where the mode information inputted from the automated driving control part 130 is the automated driving mode (mode B or C) in which the content reproduction is not permitted in the operation propriety information 188 for each mode shown in FIG. 11, the reproduction control part 172 judges it not to be switched over to the content reproduction nonrestrictive condition thereby to continue the monitoring of the automated driving mode.

Next, when the reproduction control part 172 judges it to have been switched over to the content reproduction nonrestrictive condition, it resumes the reproduction of the contents on the display device 82 (Step S209). Herein, the reproduction control part 172 reads out the contents stored in the storage part 180 and resumes the reproduction from the stop point of the contents in the above step S205. Further, the reproduction control part 172, in parallel with this reproduction of the contents, allows the storage part 180 to store the contents (for example, the contents which are received by the television receiver after the start of the reproduction) to be reproduced after resuming the reproduction of the contents. The storage part 180 is enabled to continue to store the contents after the resume of the reproduction. After that, the reproduction control part 172 completes the reproduction of the contents stored in the storage part 180 to be reproduced during the stopping period, and, thereafter, reads out the contents to be reproduced after resuming the reproduction of the contents, from the storage part 180 thereby to reproduce the contents. Thus, the reproduction control part 172 performs continuously concurrently the storage of the contents in the storage part 180 and the readout/reproduction of the contents stored in the storage part 180 in the past.

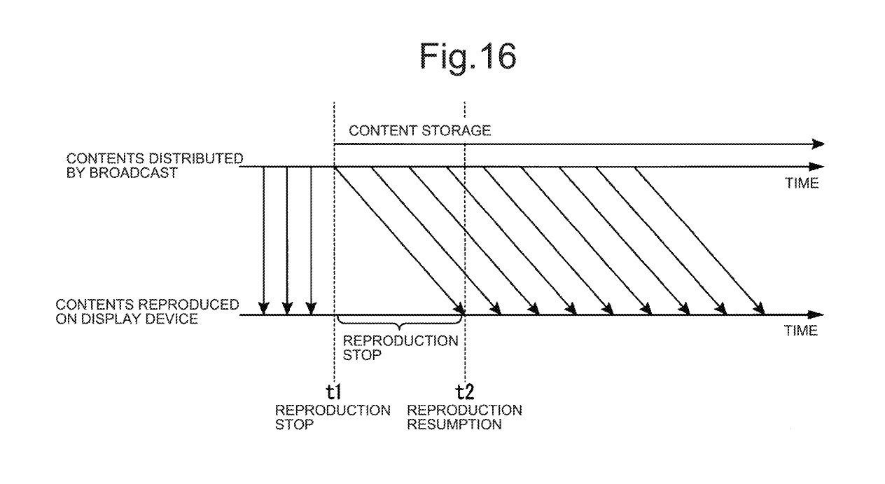

FIG. 16 is a diagram showing a relationship between the contents distributed by the broadcast and the contents reproduced on the display device 82 in the case of performing the storage, the readout and the reproduction of the contents as mentioned above. During the time when the contents is reproduced on the display device 82 in the above step S201, the contents distributed by the broadcast is reproduced on the display device 82 on a real time basis without being stored in the storage part 180. After that, when the reproduction of the contents is stopped in step S205 (time t1) and the reproduction of the contents is resumed in step S209 (time t2), the contents distributed at the time t1 are readout from the storage part 180 and reproduced on the display device 82 at the time 2. Then, the contents distributed during the stopping period (from t1 to t2) are read out from the storage part 180 thereby to be reproduced, and, thereafter, the contents distributed after resuming the reproduction of the contents (after t2) are read out from the storage part 180 thereby to be reproduced. By the way, after the reproduction of the contents are resumed at the time t2, the vehicle occupant may stop the storage, the readout and the control of reproduction of the contents as mentioned above and may switch over to the reproduction on a real time basis of the distributed contents by operating the content reproduction device 82 and the like.

According to the above embodiment, when the automated driving mode of the own vehicle M has been switched over from the content reproduction restrictive condition to the content reproduction nonrestrictive condition, the reproduction of the contents is automatically resumed, so that the vehicle occupant is not required to operate the content reproduction device at the time of resuming the reproduction of the contents. Further, since the reproduction control part 172 reads out and reproduces the contents stored in the storage part 180 to be reproduced during the stopping period (for example, the contents which are received by the television receiver during the stopping period), the vehicle occupant is able to view afterwards the contents to be reproduced during the stopping period. Therefore, it is possible to ensure the safety in the case of executing the automated driving and to improve the convenience of the content reproduction device.

### Third Embodiment

The third embodiment will be explained hereunder. The vehicle control system according to the third embodiment may employ the same configuration as the configuration of the vehicle control system 100 which is explained in the above-mentioned first embodiment. Therefore, in the following explanation, parts similar to the first embodiment are given like reference characters, and the explanation will be omitted or simplified.

As compared with the above mentioned first embodiment, the third embodiment is different in that the stop of the reproduction of the contents is previously communicated to the vehicle occupant, and, when the vehicle occupant is reluctant to stop the reproduction of the contents (namely, when the continuation of the reproduction of the contents is desired), the automated driving is controlled in such a manner as to maintain the automated driving mode in which the content reproduction is permitted.

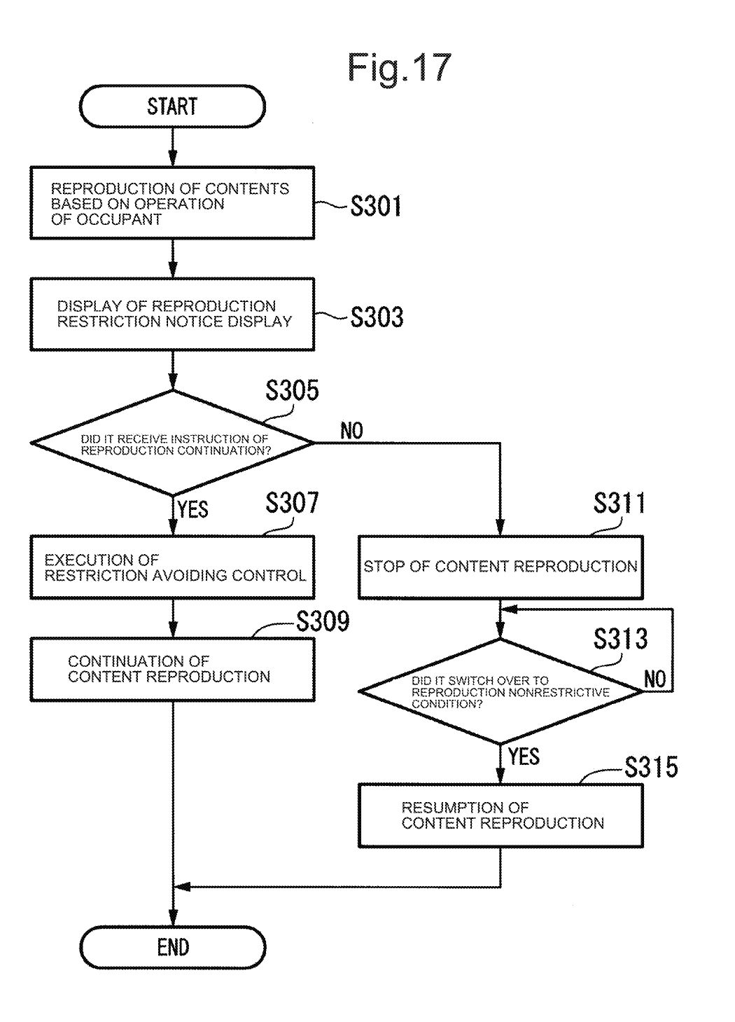

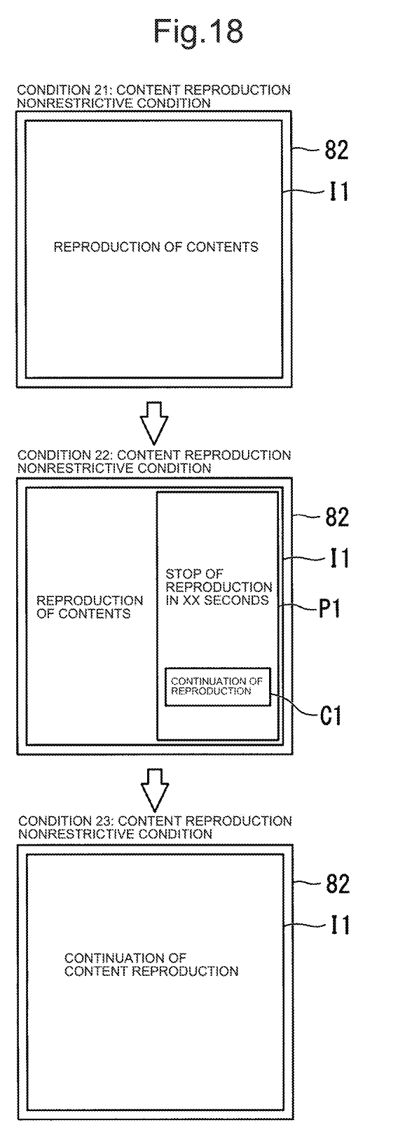

The operation or functioning in this embodiment for reproducing the contents based on the operation of the vehicle occupant on the display device 82 will be explained hereunder. FIG. 17 is a flowchart showing an example of the reproduction control processing of the contents in accordance with this embodiment. FIG. 18 is a diagram showing an example of the screen control of the display device 82 in accordance with this embodiment.

First, in the condition where the content reproduction operation is permitted (for example, the condition where the own vehicle M is stopped or the condition where the vehicle is in the automated driving mode in which the content reproduction operation is permitted), the reproduction control part 172 receives the operation of the content reproduction device 85 by the vehicle occupant and reproduces the desired contents according to the operation of the vehicle occupant on the screen I1 of the display device 82 (Step S301). Consequently, as shown in “the condition 21: content reproduction nonrestrictive condition” of FIG. 18, the contents based on the operation of the vehicle occupant are reproduced on the screen I1 of the display device 82.

Next, the reproduction control part 172 displays a reproduction restriction notice picture P1 on the screen I1 of the display device 82 based on the action plan and the like inputted from the action plan generation part 144 (Step S303). This reproduction restriction notice picture P1 is a picture for previously noticing the stop of the contents as shown in “the condition 22: content reproduction nonrestrictive condition” of FIG. 18. For example, in the case where the reproduction control part 172 refers to the action plan and judges it to switch over in XX seconds to the automated driving mode (mode B or C) in which the reproduction of the contents is not permitted, the stop notice such as “the reproduction will be stopped in XX second” is displayed on the display device 82 so as to be communicated to the vehicle occupant.

The reproduction restriction notice picture P1 may receive the instruction to continue the content reproduction, from the vehicle occupant. For example, in the case where the display device 82 is a touch panel, the instruction to continue the reproduction may be received when the vehicle occupant contacts a contact area C1 (operation receiving part) indicated as “reproduction continuation” in the reproduction restriction notice picture P1 of the display device 82. Herein, in the case of having received a signal from the automated driving control part 130 to switch over to the reproduction restriction notice, the reproduction control part 172 may display the reproduction restriction notice picture P1 on the screen I1 of the display device 82. Further, instead of or in addition to the action plan, the reproduction control part 172 may display the reproduction restriction notice picture P1 on the screen I1 of the display device 82, based on the information of surroundings of the own vehicle M, etc. inputted from the outside view recognition part 142.

Next, the reproduction control part 172 judges whether or not the instruction to continue the reproduction has been received from the vehicle occupant (Step S305). For example, the reproduction control part 172 judges whether or not the vehicle occupant has contacted the contact area C1 (operation receiving part) indicated as “reproduction continuation” in the reproduction restriction notice picture P1 of the display device 82.

When having judged that the instruction to continue the reproduction has been received from the vehicle occupant, the reproduction control part 172 transmits a signal indicating that the automated driving mode in which the content reproduction is permitted is maintained, to the automated driving mode control part 130. The automated driving mode control part 130 may adjust or change the automated driving such as driving modes, an action plan, an event to be taken, and a traveling route in accordance with the request by the vehicle occupant so as to make it possible to continue the content reproduction. The automated driving mode control part 130 which has received the signal indicating that the automated driving mode in which the content reproduction is permitted is maintained controls the automated driving in such a manner as to maintain the automated driving mode (for example, mode A) in which the content reproduction is permitted (Step S307). For example, the automated driving mode control part 130 maintains the automated driving mode in which the content reproduction is permitted, by changing the event included in the action plan (for example, by changing “the traveling lane change event” to “the lane keeping event”, etc.) before switching over to the automated driving mode of the content reproduction restrictive condition. Further, the automated driving control part 130 may maintain the automated driving mode in which the content reproduction is permitted, by changing the traveling mode within the event (for example, by changing “the medium speed traveling” to “the low speed traveling”, etc.) without changing the event included in the action plan. Further, the automated driving mode control part 130 may maintain the content reproduction by changing the route derived by the navigation device 50 (for example, by stopping the own vehicle M at the parking area or the like). In the case of having stopped the own vehicle M at the parking area, the vehicle occupant also may change the action plan and select the route capable of maintaining the automated driving mode in which the content reproduction is permitted. Thus, the reproduction of the contents on the display device 82 is continued (Step S309).

On the other hand, when having judged that the instruction to continue the reproduction has not been received from the vehicle occupant (when having reached the time to switch over to the automated driving mode of the content reproduction restrictive condition without receiving the instruction to continue the reproduction), the reproduction control part 172 stops the reproduction of the contents on the display device 82 (Step S311). Herein, as explained in the second embodiment, in the case of reproducing the contents distributed by the broadcast, the contents to be reproduced during the stopping period may be stored in the storage part 180.

Next, the reproduction control part 172 refers to the mode information inputted from the automated driving mode control part 130 and the operation propriety information 188 for each mode stored in the storage part 180 and judges whether or not the own vehicle M has switched over to the content reproduction nonrestrictive condition (Step S313). When having judged it not to switch over to the content reproduction nonrestrictive condition, the reproduction control part 172 continues the monitoring of the automated driving mode.

On the other hand, when having judged it to have switched over to the content reproduction nonrestrictive condition, the reproduction control part 172 resumes the content reproduction on the display device 82 and ends the processing in this flow chart (Step S315). Herein, in the case where the above contents are the video image contents stored in the DVD, the reproduction may be resumed from the stop point of the contents in the above step 311. As explained in the second embodiment, when resuming the reproduction of the contents distributed by the broadcast, it is possible to read out and reproduce the contents stored in the storage part 180.

According to the above embodiment, the automated driving is controlled such that to stop the reproduction of the contents is previously noticed to the vehicle occupant, and, in the case where the vehicle occupant desires to continue the reproduction of the contents, the automated driving mode in which the content reproduction is permitted is continued. Therefore, the vehicle occupant can continue the monitoring of the contents. Thus, it is possible to ensure the safety in the case of executing the automated driving and to improve the convenience of the content reproduction device.

Herein, in the case where there is the other vehicle occupant (a fellow passenger) than the vehicle occupant seated on the driver's seat of the vehicle, the above control of the content reproduction may not be performed. In this case, the judgment whether or not the fellow passenger exists (the detection of the occupant riding on the vehicle) may be performed based on the interior image imaged by the in-cabin camera (detection part) 95. Alternatively, the judgment on existence or nonexistence of the passenger may be performed such that a seat weight sensor (detection part) arranged in the seat 88 recognizes presence or absence of the seating of the passenger.

While the mode for carrying out the invention is explained by using the embodiments, it is to be understood that the present invention is not limited to the specific embodiments and that various changes and substitutions may be made in the invention without departing from the spirit and scope thereof. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

1. A vehicle control system comprising:
a content reproduction device configured to reproduce a content based on operation of an occupant of a vehicle;
an automated driving controller configured to execute an automated driving of the vehicle by automatically performing at least one of speed control and steering control of the vehicle; and
a reproduction controller configure to control the content reproduction device in accordance with a condition of the automated driving of the vehicle, the condition including a first condition and a second condition, wherein during the time that the automated driving is in the first condition, the reproduction of the content is restricted, and during the time that the automated driving is in the second condition, restriction to the reproduction of the content is released,
wherein the reproduction controller controls the content reproduction device in such a manner as to stop the reproduction of the content during the time that the automated driving is in the first condition, and enable the reproduction of the content during the time that the automated driving is in the second condition.

2. The vehicle control system according to claim 1, wherein the reproduction controller is configured to, at a time when the automated driving is switched from the second condition to the first condition, stop the reproduction of the content, then at a time when the automated driving returns from the first condition to the second condition, resume the reproduction of the content from a stopping point of the content corresponding to the time when the reproduction of the content is stopped.

3. The vehicle control system according to claim 1, wherein the content includes a video image content.

4. The vehicle control system according to claim 2, further comprising a storage device configured to store the content, wherein the reproduction controller is configured to enable the storage device to store the content to be reproduced during a stopping period when the reproduction of the content is stopped, and to enable the content stored in the storage part to be read out and reproduced when the reproduction of the content is resumed.

5. The vehicle control system according to claim 4, wherein the reproduction controller is configured such that, after having resumed the reproduction of the content, storing the content into the storage device and reading-out and reproducing the content stored into the storage device in the past are performed concurrently in parallel.

6. The vehicle control system according to claim 4, wherein the content comprises a content which is distributed by a broadcast.

7. The vehicle control system according to claim 1, further comprising a operation receiving part for receiving an instruction to continue the reproduction of the content by the content reproduction device,
wherein the automated driving controller executes any of multiple driving modes which are different in degree of the automated driving from each other, and when the operation receiving part has received the instruction to continue the reproduction of the content, maintains the driving mode which does not restrict the reproduction of the content.

8. The vehicle control system according to claim 1, further comprising a detector configured to detect the occupant riding the vehicle, wherein the reproduction controller is configured to override the stop of the reproduction of the content when the detector detects other occupant than the occupant seated on a driver's seat of the vehicle.

9. A vehicle control method executed by an on-board computer, the method comprising steps of:
executing an automated driving of a vehicle by automatically performing at least one of speed control and steering control of the vehicle; and
controlling reproduction of a content in accordance with a condition of the automated driving of the vehicle, the condition including a first condition and a second condition, wherein during the time that the automated driving is in the first condition, the reproduction of the content is restricted, and during the time that the automated driving is in the second condition, restriction to the reproduction of the content is released,
wherein the controlling step controls the content reproduction in such a manner as to stop the reproduction of the content during the time that the automated driving is in the first condition, and enable the reproduction of the content during the time that the automated driving is in the second condition.

10. A non-transitory computer readable medium storing a vehicle control program that causes an on-board computer to execute processing, the processing comprising:
executing an automated driving of a vehicle by automatically performing at least one of speed control and steering control of the vehicle; and
controlling reproduction of a content in accordance with a condition of the automated driving of the vehicle, the condition including a first condition and a second condition, wherein during the time that the automated driving is in the first condition, the reproduction of the content is restricted, and during the time that the automated driving is in the second condition, restriction to the reproduction of the content is released,
wherein the controlling step controls the content reproduction in such a manner as to stop the reproduction of the content during the time that the automated driving is in the first condition, and enable the reproduction of the content during the time that the automated driving is in the second condition.

11. The vehicle control system according to claim 1, wherein the content includes a content being displayed.

12. The vehicle control method according to claim 9, wherein the content includes a content being displayed.

13. The non-transitory computer readable medium according to claim 10, wherein the content includes a content being displayed.

14. The vehicle control system according to claim 1, wherein the automated driving controller executes any of multiple driving modes which are different in degree of the automated driving from each other, and
wherein the first condition corresponds to a driving mode having a lower degree of the automated driving than that of the driving mode corresponding to the second condition.
